(19) United States
(12) Patent Application Publication
(10) Pub. No.: US 2026/0291573 A1
(43) Pub. Date: Sep. 24, 2026

(54) METHODS FOR SWITCHING BETWEEN CSI PREDICTION METHODS BASED ON RELATIVE MONITORING METRICS

(71) Applicant: InterDigital Patent Holdings, Inc., Wilmington, DE (US)

(72) Inventors: Ahmet Serdar Tan, London (GB); Keya Patani, London (GB); Anouar Yatribi, Greater London (GB); Mihaela Beluri, Jericho, NY (US)

(73) Assignee: InterDigital Patent Holdings, Inc., Wilmington, DE (US)

(21) Appl. No.: 19/088,636

(22) Filed: Mar. 24, 2025

(51) Int. Cl. H04B 7/06; H04W 24/10

(52) U.S. Cl. CPC H04B 7/0626; H04W 24/10

(57) ABSTRACT

Methods, apparatuses, and systems are disclosed. In one example, a method performed by a wireless transmit/receive unit (WTRU) includes receiving configuration information that configures the WTRU to enable a prediction method change; receiving a plurality of inference reference signals (RSs) and a plurality of monitoring RSs; determining, based on the plurality of inference RSs and the plurality of monitoring RSs, a first monitoring score for a first CSI prediction method and a second monitoring score for a second prediction method; and sending a monitoring report that comprises the first monitoring score and the second monitoring score.

### BACKGROUND

In cellular systems, channel state information (CSI) is used to indicate how a wireless channel is being affected by factors such as device movement, physical obstacles, and environmental conditions. To ensure that quality of service (QoS) is maintained at desired levels, some facets of cellular communication may be adjusted based on CSI. For example, adaptive coding and modulation (AMC), beamforming, transmission power, and multiple-input multiple-output (MIMO) techniques that are applied at any given time may be adjusted based on CSI.

### SUMMARY

Methods and apparatuses for operation by a wireless transmit/receive unit (WTRU) in a network are provided.

In one example, a method performed by a WTRU may include receiving configuration information, wherein the configuration information comprises an indication of a relative monitoring metric and an indication to enable WTRU-initiated CSI-prediction-method change; receiving a plurality of inference channel state information reference signals (CSI-RSs) and a plurality of monitoring CSI-RSs; determining, based on the plurality of inference CSI-RSs and the plurality of monitoring CSI-RSs, a first value of a relative monitoring metric for a first CSI prediction method and a respective second value of the relative monitoring metric for each of the one or more second CSI prediction methods; determining, based on the first value of the relative monitoring metric for the first CSI prediction, a first monitoring score for the first CSI prediction method; determining, based on the respective second values of the relative monitoring metric, a respective second monitoring score for each of the one or more second CSI prediction methods; and sending a monitoring report that comprises the first monitoring score and at least one of the respective second monitoring scores.

The method may further comprise selecting a CSI prediction method from the first CSI prediction method and the one or more second CSI prediction methods based on the first monitoring score and the respective second monitoring scores, wherein the monitoring report further comprises an indication of the selected CSI prediction method.

The monitoring report may indicate a monitoring score for the selected CSI prediction method.

The method may further comprise activating the one or more second CSI prediction methods in response to receiving an indication of the set of one or more second CSI prediction methods.

The configuration information may further comprise an inference CSI-RS configuration and/or or an indication of a CSI prediction method for inference.

The configuration information may further comprise a CSI-RS monitoring configuration. Furthermore, the method may further comprise receiving the plurality of inference CSI-RSs and the plurality of monitoring CSI-RSs based on the CSI-RS monitoring configuration.

The CSI-RS monitoring configuration may comprise an indication of a monitoring window size, an indication that periodic and/or semi-persistent bursts of CSI-RS are to be used, and/or an association between the plurality of monitoring CSI-RSs and the plurality of inference CSI-RSs.

The monitoring report may further indicate a relative intermediate key performance indicator (KPI) for the first CSI prediction method and/or a relative intermediate KPI for at least one of the one or more second CSI prediction methods.

The configuration information may further comprise a first threshold to be applied to a relative intermediate key performance indicator (KPI) between an AI-based CSI prediction method and a non-AI CSI prediction method.

The configuration information may further comprise a second threshold to be applied to a relative intermediate KPI between an AI-based CSI prediction method and a sample-and-hold (S&H) CSI prediction method.

In another example, a method performed by a WTRU may include receiving configuration information that configures the WTRU to enable a prediction method change; receiving a plurality of inference reference signals (RSs) and a plurality of monitoring RSs; determining, based on the plurality of inference RSs and the plurality of monitoring RSs, a first monitoring score for a first CSI prediction method and a second monitoring score for a second prediction method; and sending a monitoring report that comprises the first monitoring score and the second monitoring score.

### BRIEF DESCRIPTION OF THE DRAWINGS

FIG. 1A is a system diagram illustrating an example communications system in which one or more disclosed embodiments may be implemented.

FIG. 1B is a system diagram illustrating an example wireless transmit/receive unit (WTRU) that may be used within the communications system illustrated in FIG. 1A according to an embodiment.

FIG. 1C is a system diagram illustrating an example radio access network (RAN) and an example core network (CN) that may be used within the communications system illustrated in FIG. 1A according to an embodiment.

FIG. 1D is a system diagram illustrating a further example RAN and a further example CN that may be used within the communications system illustrated in FIG. 1A according to an embodiment.

FIG. 2 depicts an example timeline for a configuration in which periodic or semi-persistent bursts of CSI-RSs are to be used for inference CSI-RSs.

FIG. 3 depicts an example timeline for a configuration in which periodic or semi-persistent CSI-RSs are to be used for inference CS-RSs and in which some inference CSI-RSs are also used as monitoring CSI-RSs.

### DETAILED DESCRIPTION

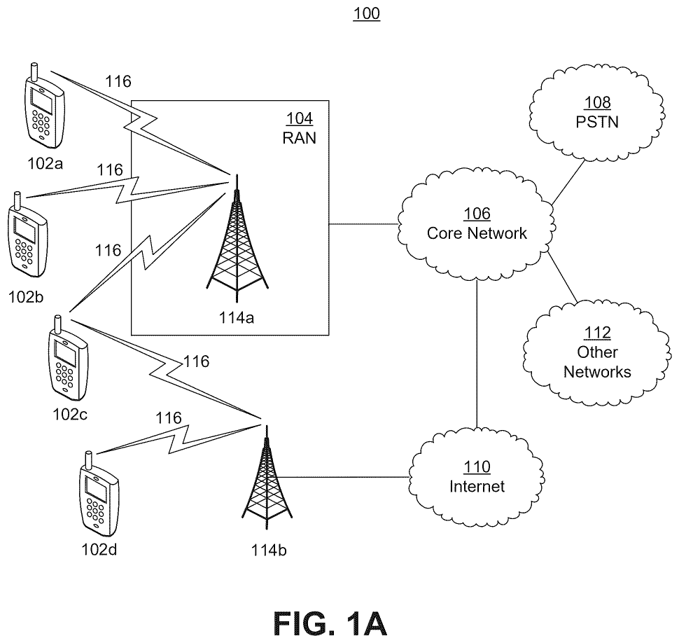

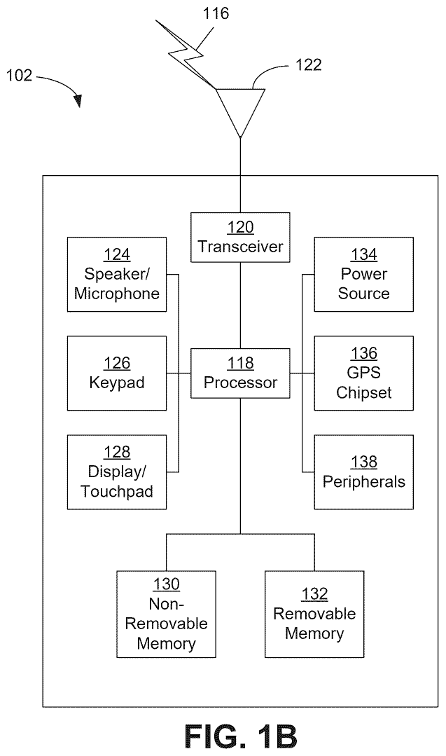

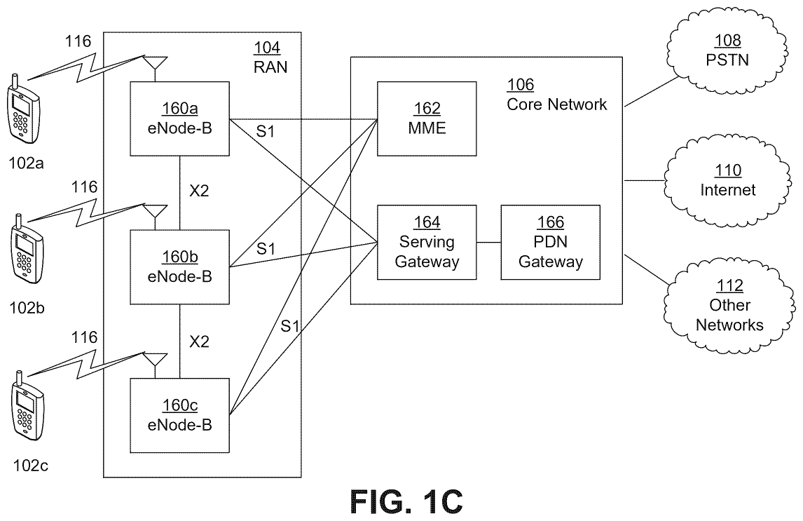

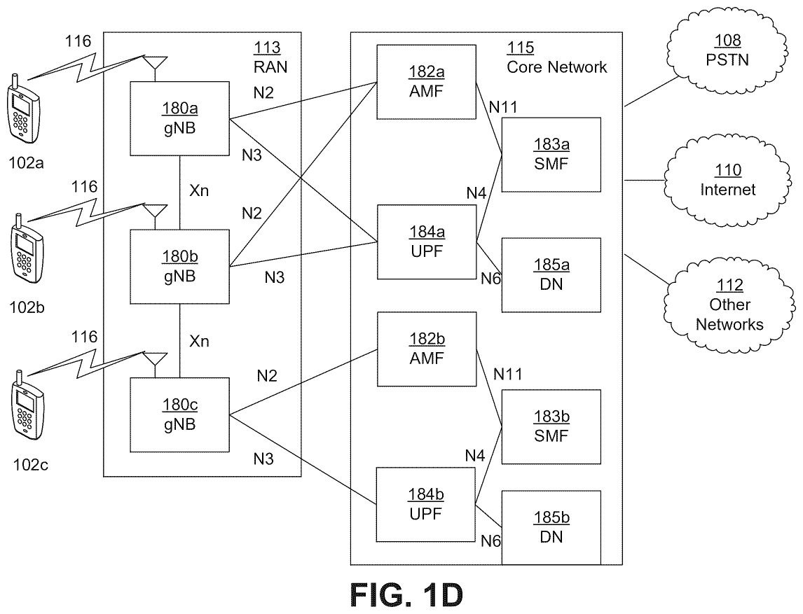

FIG. 1A is a diagram illustrating an example communications system 100 in which one or more disclosed embodiments may be implemented. The communications system 100 may be a multiple access system that provides content, such as voice, data, video, messaging, broadcast, etc. to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a WTRU.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134 and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit 139 to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remain idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (COMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating WTRU IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-ab, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may perform testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Channel State Information (CSI) Prediction is a use case under the Third Generation Partnership Project (3GPP) Radio Access Network Technical Specification Group (TSG) Radio Access Network (RAN) working group Radio layer 1 (RAN-1) release 19 (Rel-19) work item “Study on Artificial Intelligence (AI)/Machine Learning (ML) for NR Air Interface.” In the CSI prediction use case, a WTRU predicts one or more instances of future CSI (e.g., channel matrices (or Precoding Matrix Indicators (PMIs) Ĥ(t+1), . . . , Ĥ(t+N4), where N4 may be a configurable parameter that indicates an integer number of predicted CSI instances and t may represent a current time slot interval) by using the current and historical CSI measurements H(t−K), . . . , H(t) (where t may represent a current time slot interval and K may represent an integer number of past CSI instances that may be used for prediction). The WTRU may then report the predicted CSI to the network. The CSI prediction use case aims to enhance downlink communications by enabling more accurate CSI information at the network. Typically, CSI prediction is WTRU-sided (e.g., performed by the WTRU). Monitoring for CSI prediction methods (e.g., including CSI-RS configuration, monitoring metrics, and monitoring feedback to the network) is used to ensure good performance.

The CSI prediction monitoring metric feedback may be based on squared generalized cosine similarity (SGCS) or normalized mean square error (NMSE) between the measured ground-truth CSI and the predicted CSI. However, feedback of the SGCS and/or NMSE values may not be indicative of how well an AI-based CSI prediction method used to generate the predicted CSI operates compared to baseline (e.g., benchmark) prediction methods such as sample-and-hold (S&H) CSI prediction methods and/or non-AI CSI prediction methods.

Thus, one problem that arises is how to enable a monitoring metric that is more indicative of the relative performances of different CSI prediction methods.

For such a monitoring metric, a long monitoring window may be helpful because, if there are few observations on the monitoring metric, those few observations may not be indicative of the actual operational performance of the CSI prediction methods (e.g., the few observations may be too small of a sample size to represent the performance of the CSI prediction methods accurately). However, a long monitoring window may bring latency in (e.g., delay) a method-monitoring-outcome evaluation at the network and may further bring latency in (e.g., delay) switching from one CSI prediction method to another CSI prediction method at the WTRU (e.g., if a monitoring report is provided as feedback at the end of the long monitoring window). On the other hand, a short monitoring window may bring (e.g., cause) large signaling overhead due to frequent configuring of monitoring CSI-RSs, and/or frequent feedback being sent. In addition, an SGCS that is averaged over a monitoring window may not be indicative of the overall performance of a CSI prediction method, as a few predicted CSI may show very low SGCS (outliers that may distort the average) due to channel conditions even if other predicted CSI are more indicative of the overall performance of the CSI prediction method.

Thus, another problem that arises is how to define a more efficient monitoring mechanism at the WTRU based on relative performances of CSI prediction methods.

The present disclosure describes technological solutions for addressing the problems described above. In some examples, a WTRU receives configurations (e.g., in the form of configuration information received from the network) that indicate a relative monitoring metric to be computed based on comparison to a benchmark CSI prediction method, receives inference and/or monitoring CSI-RSs, computes respective values of the relative monitoring metric and/or respective relative monitoring scores for active CSI prediction methods, switches the CSI prediction method (e.g., the foreground-active CSI prediction method on which feedback reported to the network is based) based on the values of the relative monitoring metric and the respective relative monitoring scores, and reports relative intermediate Key Performance Indicators (KPI), the respective relative monitoring scores, and the selected CSI prediction method (e.g., the CSI prediction method to which the switch was made).

In some examples, the WTRU may be configured with one or more relative monitoring metrics and/or WTRU-initiated CSI-Prediction-method change. For instance, the WTRU may be configured via configuration information that is received from the network and that indicates the one or more relative monitoring metrics and/or the enablement of WTRU-initiated CSI-Prediction-method change.

For a relative monitoring metric, the configuration information may indicate a benchmark CSI prediction method to be used in computing values of the relative monitoring metric. The benchmark CSI prediction method may be, for example, an S&H CSI prediction method and/or a non-AI CSI prediction method.

The configuration information may further indicate an intermediate KPI-based performance metric (e.g., that measures SGCS and/or NMSE) to be used in computing values of the relative monitoring metric.

The configuration information may further indicate the relative monitoring metric to be computed. The relative monitoring metric may be based on, for example, an intermediate KPI difference, a percentage of change, and/or a ratio of computed intermediate KPIs.

The configuration information may further indicate a monitoring-score-per-prediction method for computing the respective relative monitoring scores of CSI prediction methods. For instance, in some examples, the monitoring-score-per-prediction method may be the average intermediate KPI of a configured CSI prediction method relative to the average intermediate KPI of the configured benchmark CSI prediction method. Furthermore, in some examples, the monitoring-score-per-prediction method may involve determining a number of instances for which a CSI prediction method (e.g., an AI-based a CSI prediction method) performed better (e.g., produced more accurate predictions (e.g., higher SGCS or lower NMSE) than a benchmark a CSI prediction method (e.g., an S&H CSI prediction method) and/or a non-AI CSI prediction method. Also, in some examples. The monitoring-score-per-prediction method may involve determining a number of instances for which one or more active a CSI prediction methods outperformed other CSI prediction methods (e.g., inactive CSI prediction methods).

The configuration information may further indicate a configuration for an inference CSI reference signal (CSI-RS) (e.g., an inference CSI-RS configuration).

In some examples, the inference CSI-RS configuration indicates that periodic and/or semi-persistent bursts of CSI-RSs are to be used (e.g., Periodic/Semi-Persistent (P/SP) configuration for Release 18 (Rel-18) Aperiodic CSI-RS).

Furthermore, in some examples, the inference CSI-RS configuration indicates that periodic and/or semi-persistent CSI-RSs are to be used.

The configuration information may further comprise an indication to enable WTRU-initiated CSI-prediction-method change (e.g., during a monitoring window). Furthermore, in some examples, the configuration information may further comprise one or more thresholds to apply to an average relative intermediate KPI such that, when a threshold is satisfied, the WTRU may change CSI prediction methods (e.g. switch from one CSI prediction method to another). The thresholds may depend on the specific CSI prediction methods that are being compared. For instance, a first threshold may be applied to a relative intermediate KPI between an AI CSI prediction method and a non-AI CSI prediction method, while a second threshold may be applied to a relative intermediate KPI between an AI CSI prediction method and an S&H CSI prediction method. Also, the configuration information may comprise one or more thresholds to apply to a number of instances such that, when a threshold is satisfied, the WTRU may change CSI prediction methods (e.g. switch from one CSI prediction method to another).

The configuration information may further indicate a prediction method (e.g., a CSI prediction method) for inference. For example, the configuration information may indicate a prediction method per prediction time instance.

The WTRU may receive one or more inference CSI-RSs, compute a predicted CSI via a first CSI prediction method (e.g., a foreground-active CSI prediction method) based on the one or more inference CSI-RS, and report the predicted CSI (e.g., to the network). In addition to being used for computing and reporting the predicted CSI during inference, the first CSI prediction method may be used for performance metric computation (e.g., for computing values of a relative monitoring metric, an intermediate KPI-based performance metric, etc.) based on one or more monitoring CSI-RSs.

The WTRU may receive a configuration for monitoring CSI-RSs (e.g., in the form of configuration information). The configuration information may indicate a monitoring window size (“Wₘ”). In addition, the configuration information may indicate that periodic and/or semi-persistent bursts of CSI-RSs are to be used (e.g., P/SP configuration for Rel-18 Aperiodic CSI-RS). For example, the configuration information may indicate an association between one or more monitoring CSI-RSs and one or more inference CSI-RSs.

The WTRU may be configured with (e.g., receive configuration information that indicates) a set of one or more second CSI prediction methods (e.g., a set of background-active methods). The one or more second prediction methods may be used for performance metric computation (e.g., of respective values of a relative monitoring metric, respective values of an intermediate KPI-based performance metric, etc.) based on monitoring CSI-RSs.

The set of one or more second prediction methods may be determined and/or selected based on: activation of available CSI predictions methods, a determination of which CSI prediction methods are available, and/or indication from the network. The one or more second prediction methods in the set may be used for computing one or more respective predicted CSIs at the WTRU. However, in one example, the WTRU does not report the one or more respective predicted CSIs that were computed using the one or more second prediction methods (by contrast, the WTRU does report the predicted CSI that was computed using the first CSI prediction method in this example).

The WTRU may receive one or more inference CSI-RSs and/or one or more monitoring CSI-RSs during the monitoring window.

In addition, the WTRU may compute respective values of the relative monitoring metric for the first prediction method and for each of the one or more second prediction methods in the set (e.g., by comparing intermediate KPIs of the first prediction method and the one or more second prediction methods to intermediate KPIs of one or more benchmark CSI prediction methods such as S&H) based on the received one or more monitoring CSI-RSs.

For instance, in an example, the WTRU may compute a respective average relative intermediate KPI between each CSI prediction method (e.g., the first CSI prediction method and the one or more second CSI prediction methods) and a benchmark CSI prediction method (e.g., that was indicated via configuration information).

The WTRU may also compute a respective relative SGCS for each CSI prediction method (e.g., the first CSI prediction method, the one or more second CSI prediction methods relative to the benchmark CSI prediction method) and/or for each monitoring instance may be computed. A “monitoring instance” may refer to a ground-truth CSI that is measured via monitoring of a particular CSI-RS received within the monitoring window, which may be used to measure the intermediate KPIs (e.g., SGCS of the first and second CSI prediction methods).

The WTRU may compute a respective relative monitoring score for each CSI prediction method. In one example, the respective relative monitoring score for a CSI prediction method may comprise a number of monitoring instances for which the CSI prediction method outperformed the benchmark CSI prediction method (e.g., the CSI that the CSI prediction method predicted was more accurate than the CSI that the benchmark CSI method predicted). Intermediate KPIs (e.g., such as SGCS and/or NMSE) may be used to assess accuracy and/or performance.

In an example, the WTRU may compute the respective relative monitoring score for a CSI prediction method by computing a stream of bits. Each bit in the stream may correspond to a monitoring instance (e.g., such that consecutive bits correspond to consecutive monitoring instances). A value of one at a bit in the stream may indicate that the CSI prediction method outperformed the benchmark CSI prediction method for the monitoring instance (e.g., ground-truth CSI) to which the bit corresponds. For example, if the respective relative monitoring score for a CSI prediction method is represented by the stream of ten bits “1110110111,” then the CSI prediction method outperformed the benchmark CSI prediction method for eight out of ten monitoring instances (although the benchmark CSI prediction method performed better for the fourth and seventh monitoring instances).

In one option, the WTRU may compute a separate relative monitoring score for each prediction instance (e.g., predicted CSI) for N₄>1.

In another option, the WTRU may compute the top prediction method based on the monitoring-score-per-prediction method.

The WTRU may select a CSI prediction method from one of the first CSI prediction method or set of one or more second CSI prediction methods based on the computed respective values of the relative monitoring metrics for each of the first CSI prediction method and the one or more second CSI prediction methods in the set.

For example, the WTRU may select a second CSI prediction model from the set of one or more second CSI prediction models if the WTRU determines the respective value of the relative monitoring metric for the second CSI prediction model is better than (e.g., in the case of SGCS, greater than and/or greater than by at least a threshold amount or, in the case of NMSE, less than and/or less than by at least a threshold amount) that of the first CSI prediction model for a set of one or more prediction instances. (A “prediction instance” may refer to a predicted CSI that can be compared to a corresponding ground-truth CSI, where the ground-truth CSI is measured based on a CSI-RS received in the monitoring window).

In an example, the WTRU uses the selected second CSI prediction method for computing and reporting predicted CSIs during inference. The WTRU may use the first CSI prediction method for subsequent performance metric computation, but does not report CSIs predicted by the first CSI prediction method (e.g., because the selected second CSI prediction method serves the foreground-active CSI prediction method after being selected instead of the first CSI prediction method).

In another example, the WTRU may switch the CSI prediction method (e.g., the foreground-active CSI prediction method on which feedback reported to the network is based) based on a network indication (e.g., included in configuration information) after the end of the monitoring window.

Optionally, in some examples, the WTRU may compute relative monitoring scores separately for each prediction instance and change (e.g., switch) the CSI prediction method (e.g., the foreground-active CSI prediction method) for each prediction instance separately.

The WTRU may transmit a monitoring report to the network. The monitoring report may comprise one or more respective relative intermediate KPIs (e.g., average relative intermediate KPIs) for the first CSI prediction method and/or the one or more second prediction methods.

The monitoring report may comprise a respective relative monitoring score for each CSI prediction method (e.g., the first CSI prediction method, the one or more second CSI prediction methods, and/or the benchmark CSI prediction method).

The monitoring report may indicate the top-performing CSI prediction method (e.g., from among the first CSI prediction method, the one or more second CSI prediction methods, and/or the benchmark CSI prediction method) based on the respective relative monitoring scores.

The monitoring report may indicate the selected second CSI prediction method.

The technological solutions described herein provide a number of benefits. For instance, the monitoring-score-per-prediction method reduces monitoring overhead. In addition, the WTRU may switch the CSI prediction method (e.g., the foreground-active CSI prediction method) during monitoring (e.g., without waiting for instruction from the network), thereby allowing CSI prediction to achieve and maintain high levels of accuracy even amidst abrupt changes in channel conditions. The technological solutions described herein may also provide other benefits. Several examples of technological solutions are provided below, although other examples are also possible.

A WTRU that is capable of CSI prediction may receive configuration information regarding performance monitoring of the CSI prediction methods. As described in further detail in examples below, the configuration information may specify one or more of: CSI prediction methods for which performance is to be measured, types of KPI to be used for measuring performance, a relative monitoring metric to be used for measuring performance, a benchmark CSI prediction method, a type of relative monitoring score, an inference reference signal configuration, an indication of whether the WTRU is enabled (e.g., permitted) to use WTRU-initiated CSI prediction method change, and/or CSI prediction methods to be used for individual prediction instances.

In an example, the configuration information may indicate CSI Prediction methods. The WTRU may receive configuration information that specifies a first CSI prediction method based on the WTRU's capability (e.g., the first CSI prediction method may be an AI-based CSI prediction method the WTRU is capable of using). The WTRU may also receive configuration information that specifies a set of second CSI prediction methods based on the WTRU's capability (e.g., non-AI-based CSI prediction methods such as a Kalman-based CSI prediction method and/or an autoregression-based CSI prediction method, an S&H CSI prediction method, etc.).

In an example, the configuration information may indicate a type of intermediate KPI to be used for measuring performance (e.g., SGCS and/or NMSE). The intermediate KPI may provide a measure of the similarity between a predicted CSI (computed by a CSI prediction method) and a ground-truth CSI (computed using a measured CSI-RS).

In an example, the configuration information may indicate a relative monitoring metric to be used. The relative monitoring metric may refer to a performance metric that is computed by comparing the performance (e.g., intermediate KPI) of a first CSI prediction method to the performance (e.g., intermediate KPI) of a second CSI prediction method. In one example, the relative monitoring metric may be computed by determining a difference between the respective intermediate KPIs of the first CSI prediction method and the second CSI prediction method. In another example, the relative monitoring metric may be computed by determining a percentage of change between the respective intermediate KPIs of the first CSI prediction method and the second CSI prediction method. In another example, the relative monitoring metric may be computed by determining a ratio between the respective intermediate KPIs of the first CSI prediction method and the second CSI prediction method.

In an example, the configuration information may indicate a benchmark CSI prediction method. The WTRU may be configured to use the benchmark CSI prediction method to compute a relative monitoring metric between a first CSI prediction method and the benchmark CSI prediction method. For example, the benchmark CIS prediction method may be an S&H CSI prediction method and/or a non-AI based CSI prediction method.

In an example, the configuration information may indicate a type of relative monitoring score (e.g., to be used for measuring and/or reporting performance). Based on the type of relative monitoring score, the WTRU may compute and report a respective relative monitoring score for each CSI prediction method. The respective relative monitoring scores may indicate a performance comparison between the CSI prediction methods.

The WTRU may be configured to compute and report the average value of a relative monitoring metric for each CSI prediction method (e.g., where the average value of the relative monitoring metric for a CSI prediction model may serve as the respective relative monitoring score for that CSI prediction model). The WTRU may compute the average value of the relative monitoring metric over a monitoring window (e.g., indicated via configuration information that specifies a monitoring configuration).

In an example, the WTRU may be configured to compute and report the number of instances for which a first CSI prediction method's intermediate KPI is better than a benchmark CSI prediction method's intermediate KPI. As another option, the WTRU may be configured to compute and report the instances for which a first CSI prediction method's intermediate KPI is higher than a benchmark CSI prediction method's intermediate KPI(s).

In an example, the WTRU may be configured to compute and report the number of instances for which a first CSI prediction method's intermediate KPI is higher than a set of second prediction methods' intermediate KPI. As another option, the WTRU may be configured to compute and report the instances for which a first CSI prediction method's intermediate KPI is higher than a set of second prediction methods' intermediate KPIs.

In an example, the configuration information may indicate an inference reference signal (e.g., CSI-RS) configuration. The WTRU may receive an inference CSI-RS (e.g., based on the CSI-RS configuration) and use the received inference CSI-RS to compute a predicted CSI using the first CSI prediction method.

In accordance with the inference reference signal configuration, the WTRU may receive periodic or semi-persistent CSI-RSs. As another option, the WTRU may receive periodic and/or semi-persistent bursts of CSI-RSs (e.g., a P/SP extension of the Rel-18 aperiodic CSI-RS configuration).

In an example, the configuration information may include an indicator to enable a WTRU-initiated CSI prediction method change. The indicator may enable the WTRU (e.g., indicate that the WTRU is permitted and/or is instructed) to change the CSI prediction method (e.g., the foreground-active CSI prediction method) during a monitoring window. If the WTRU is configured with the indicator (e.g., receives the indicator in the configuration information), the WTRU may further receive (e.g., in the configuration information) one or of the conditions described in the following examples.

In an example, a condition may comprise one or more thresholds to be applied to relative intermediate KPIs. The one or more thresholds may be configured for (e.g., designated for) different pairs of CSI prediction methods (e.g., a first threshold may be designated for the relative intermediate KPI between a pair that includes an AI-based CSI prediction method and a non-AI CSI prediction method, while a second threshold may be designated for the relative intermediate KPI between a pair that includes an AI-based CSI prediction method and an S&H CSI prediction method).

In an example, a condition may specify a minimum number of monitoring instances to change the CSI prediction method (e.g., such that the foreground-active CSI prediction method is not permitted to be changed until at least the minimum number of monitoring instances have been taken into consideration).

In an example, a condition may comprise one or more applicable/channel conditions. When the one or more applicable/channel conditions are satisfied, the WTRU may change (e.g., switch) the CSI prediction method (e.g., the foreground-active CSI prediction method) during the monitoring window.

In an example, the configuration information may specify a respective CSI prediction method for each of a plurality of prediction instances. For example, the configuration information may indicate that a first CSI prediction method is to be used for a first prediction instance and that a second CSI prediction method is to be used for a second prediction instance.

In an example, the configuration information may specify timing information and uplink resources for the WTRU to report the monitoring report to the network. For example, the configuration information may indicate a slot index and/or uplink space-time-frequency resources.

A WTRU may receive an inference CSI-RS to be used to compute and/or report one or more predicted CSI (e.g., based on the inference CSI-RS) using a first CSI prediction method (e.g., a foreground-active CSI prediction method). The first CSI prediction method (e.g., foreground-active CSI prediction method) may be configured by the network (e.g., indicated via configuration information) and/or selected by the WTRU (and approved by the network) during a previous iteration of a monitoring process. The first CSI prediction method (e.g., the foreground-active CSI prediction method) may be used for computing and reporting one or more predicted CSIs during inference, as well as for computing one or more values of a performance metric based on a monitoring CSI-RS during the monitoring process (e.g., a current iteration of the monitoring process).

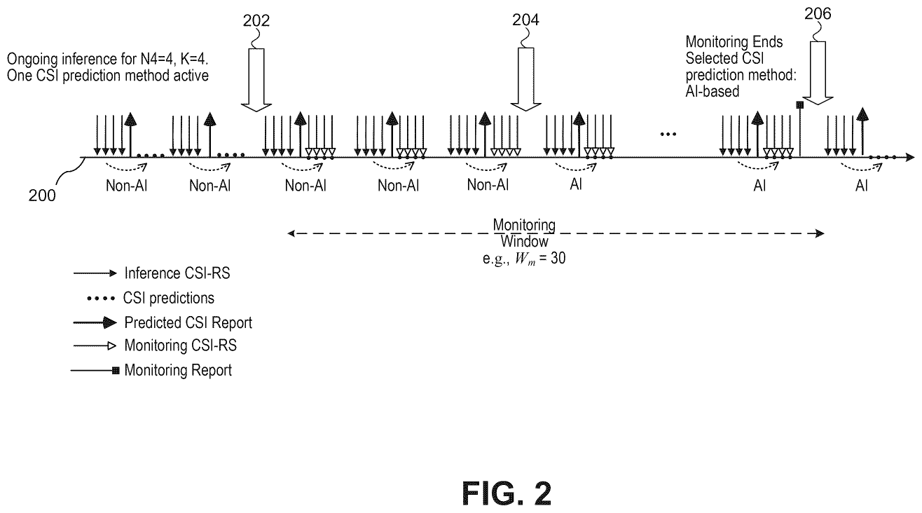

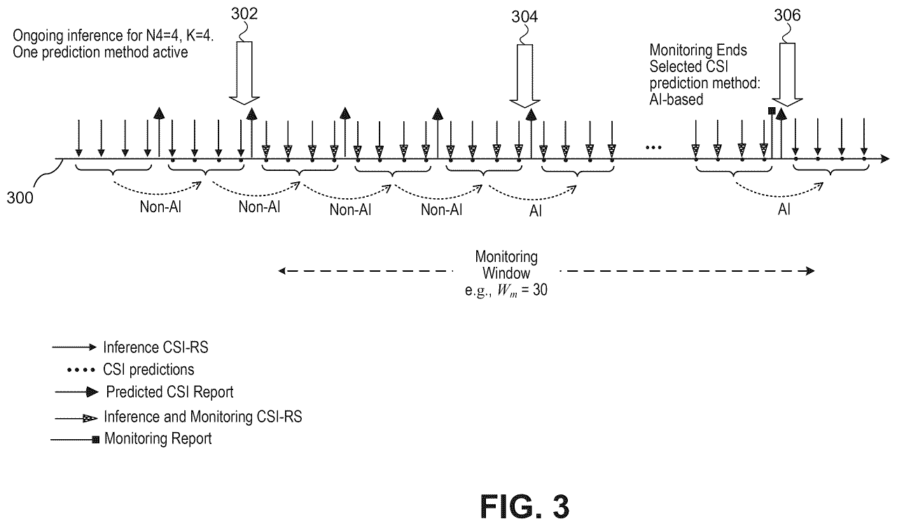

In both FIG. 2 and FIG. 3, for example, the WTRU starts inference (e.g., prediction of CSIs) using a non-AI based CSI prediction method (e.g., a first CSI prediction method and/or a foreground-active CSI method) with parameter values N₄=4 and K=4, wherein the downward-pointing arrows with solid black arrowheads that touch the timeline 200 of FIG. 2 or the timeline 300 of FIG. 3 indicate the inference CSI-RSs).

The WTRU may receive configuration information that comprises a configuration for monitoring CSI-RSs, which may initiate a monitoring process at the WTRU. For example, at the arrow 202 in FIG. 2 (and at the arrow 302 in FIG. 3) the WTRU receives the configuration for monitoring CSI-RSs (e.g., the monitoring configuration). Multiple CSI prediction methods are activated (e.g., the first CSI prediction method-which may be an initial and/or non-AI CSI prediction method- and one or more second CSI prediction methods) and monitoring starts (e.g., for N₄=4). The configuration for monitoring CSI-RSs may comprise one or more types of information described in the examples below.

In an example, the configuration for monitoring CSI-RSs may comprise a monitoring window size (e.g., Wₘ). The WTRU may receive a monitoring window size which may determine how many monitoring CSI-RSs the WTRU may receive (e.g., during a monitoring window). The monitoring window size may be configured, for example, as a number of slots, a duration (e.g., of time), or a number of CSI-RSs. The configuration for monitoring CSI-RSs may correspond to all and/or a subset of the prediction instances.

In an example, the configuration for monitoring CSI-RSs may comprise a configuration for monitoring reports. The configuration for monitoring reports may specify, for example, a time slot for a monitoring report after a corresponding monitoring window and/or uplink resources to use for reporting (e.g., sending) the monitoring report.

In an example (e.g., depicted in FIG. 2), the configuration for monitoring CSI-RSs may indicate that periodic or semi-persistent bursts of CSI-RSs are to be used for inference CSI-RSs (e.g., P/SP configuration for 3GPP Rel-18 Aperiodic CSI-RS). If this is the case, the configuration for monitoring CSI-RSs may also indicate that periodic or semi-persistent bursts of CSI-RSs are to be used for monitoring CSI-RSs (e.g., as depicted in FIG. 2, wherein the downward-pointing arrows with hollow black arrowheads that touch the timeline 200 indicate the monitoring CSI-RSs). The monitoring CSI-RSs may be additional CSI-RSs that the WTRU receives for the purpose of monitoring.

In an example (e.g., depicted in FIG. 3), the configuration for monitoring CSI-RSs may indicate a P/SP CSI-RS configuration (e.g., a configuration for P/SP monitoring CSI-RSs). For example, if the WTRU was configured with legacy periodic or semi-persistent CSI-RSs, then the WTRU may receive such a configuration for P/SP monitoring CSI-RSs. In this case, the WTRU may not receive additional CSI-RSs and may instead use the inference CSI-RSs, which were already configured and received during inference, for monitoring. In FIG. 3, the downward-pointing arrows with checkered black arrowheads that touch the timeline 300 indicate the CSI-RSs that are used as both inference CSI-RSs and monitoring CSI-RSs.

As another option, if the WTRU was configured with periodic or semi-persistent bursts of CSI-RSs for inference, the WTRU may be configured with one or more legacy P/SP CSI-RSs for monitoring a single prediction instance. In this case, the WTRU may receive additional P/SP CSI-RSs for monitoring.

The WTRU may receive configuration information that indicates a set of one or more second CSI prediction methods (e.g., a set of background-active CSI prediction methods). The one or more second CSI prediction methods may be used for performance metric computation based on monitoring CSI-RSs. The set of one or more second CSI prediction methods may be used for computing predicted CSIs at the WTRU, but the computed predicted CSIs are not reported. The WTRU may determine (e.g., identify and/or select) the set of one or more second prediction methods based on one or more factors, as described in the examples below.

An example factor may be activation of available CSI prediction methods (e.g., available CSI prediction models). In this example, the WTRU may have a set of available CSI prediction models. A subset of the available CSI prediction methods may be activated to be part of the set of second CSI prediction methods. The WTRU may determine which available CSI prediction methods to activate based on the available resources at the WTRU or based on a network configuration.

An example factor may be determination of available CSI prediction methods. The WTRU may determine which CSI prediction models are available based on the WTRU's capabilities, on a transfer of one or more CSI prediction methods from the network, and/or on training a CSI prediction method (e.g., a CSI prediction model) based on an indication from the network (e.g., in the configuration information).

An example factor may be an indication from the network. The WTRU may determine the set of second CSI prediction methods based on a network configuration.

In an example, the WTRU computes respective values of the relative monitoring metric based on the received monitoring CSI-RSs, the first CSI prediction method (e.g., which may be an AI-based CSI prediction method), and a set of one or more second CSI prediction methods (e.g., which may be autoregressive CSI prediction models, S&H CSI prediction models, etc.). The WTRU may compute one or more values of the relative monitoring metric between (i) the first CSI prediction method and/or the one or more second CSI prediction methods and (ii) the one or more benchmark CSI prediction methods.

As one option, the WTRU may compute a respective value of the relative monitoring metric for each monitoring instance. Values of the relative monitoring metric may be computed via the function ƒ(KPI_{AIML}, KPI_{benchmark}). The function ƒ may be the a difference (e.g., between respective intermediate KPIs for a pair of CSI prediction methods that are being compared), a percentage of change (e.g., between respective intermediate KPIs for a pair of CSI prediction methods that are being compared), and/or a ratio of respective intermediate KPIs (e.g., for the first CSI prediction method and the one or more benchmark CSI prediction methods). The WTRU may be configured to compute values of the relative monitoring metric for multiple KPIs (e.g., values indicated by the set {SGCS_{AIML}−SGCS_{S&H}, SGCS_{AIML}−SGCS_{Kalman}, NMSE_{AIML}−NMSE_{S&H}, NMSE_{AIML}−NMSE_{Kalman}}).

As another option, the WTRU may compute an average of relative intermediate KPIs between each CSI prediction method and a benchmark CSI prediction method (e.g., as indicated by the expression

$$\frac{1}{2} ( f ( {KPI}_{AIML} , {KPI}_{S \& H} ) + f ( {KPI}_{AIML} , {KPI}_{kalman} ) ) ) .$$

In an example, the WTRU may compute a respective relative monitoring score for each CSI prediction method based on the computed respective values of the relative monitoring metric.

As one option, a relative monitoring score may be computed as the number of instances for which the first prediction method outperformed one or more benchmark CSI prediction methods within the configured monitoring window. Consider an example in which (i) the first CSI prediction method is an AI-based CSI prediction method (e.g., a AI/ML CSI prediction model), (ii) the one or more benchmark CSI prediction methods are a Kalman-filter CSI prediction method and an S&H CSI prediction method, and (iii) there are ten monitoring instances (e.g., ground-truth CSIs. In this example, if the first CSI prediction method shows relative gains over (e.g., outperforms) both the Kalman-filter CSI prediction method and the S&H CSI prediction method in five of those monitoring instances and in the remaining 5 instances shows relative gains over (e.g., outperforms) the S&H CSI prediction method alone for the other five monitoring instances, the relative monitoring score may be computed as (5×2)+(5×1)=15.

As another option, the WTRU may compute a stream of bits representing when the first CSI prediction method was better than (e.g., outperformed) a benchmark CSI prediction method (e.g., as described with respect to the example stream of bits 1110110111 for Wₘ=10 in an example above). A threshold for a binary score in the stream of bits may be determined based on one or more of the criteria described in the following examples.

As one criterion, if the first CSI prediction method has a better intermediate KPI than the benchmark CSI prediction method for a monitoring instance, then the binary value associated with that monitoring instance may be set to one. Otherwise, the binary value associated with that monitoring instance may be set to zero.

As another criterion, if the value of the relative monitoring metric between the first CSI prediction method and the benchmark CSI prediction method is greater than a configured threshold for a monitoring instance, then the binary value associated with that monitoring instance may be set to one. Otherwise, the binary value associated with that monitoring instance may be set to zero.

As another criterion, if the ratio of one relative monitoring metric to another is above (e.g., greater than) a threshold, then the binary value associated with that monitoring instance may be set to one. In one example, the ration may be computed via the function

$$\frac{f ( {KPI}_{AIML} , {KPI}_{kalman} )}{f ( {KPI}_{AIML} , {KPI}_{S \& H} )} .$$

In this example, the WTRU may elect to continue using the first CSI prediction model (e.g., an AI-based CSI prediction model) if the first CSI prediction model exhibits consistent gains over one benchmark CSI prediction method (e.g., a Kalman-Filter CSI prediction method) rather than another benchmark CSI prediction method (e.g., an S&H CSI prediction method).

As another option, there may be a separate relative monitoring score for each prediction instance in scenarios where N₄>1. For example, if N₄=1, the WTRU may compute four separate relative monitoring scores.

In another option, the WTRU may compute (e.g., determine and/or identify) a top-performing CSI prediction method based on a monitoring-score-per-prediction method.

In an example, the WTRU may select a CSI prediction method from one of the active CSI prediction method (e.g., a first prediction method and/or foreground-active method) and a set of one or more second CSI prediction methods (e.g., background-active CSI prediction methods). The WTRU may make the selection as a function of the respective values of the determined relative monitoring metric for active CSI prediction methods with respect to one or more benchmark CSI prediction methods. For example, the WTRU may switch to an AI-based CSI prediction method from a non-AI CSI prediction method. For example, at the arrow 204 in FIG. 2 (and at the arrow 304 in FIG. 3), the WTRU may switch the foreground-active CSI prediction method based on the respective values of the relative monitoring metric.

In one example, the WTRU may select and/or switch to a second CSI prediction method (e.g., changes the foreground-active CSI prediction method) if one or more of the conditions described in the examples below apply (e.g., are satisfied).

As one condition, if the value of the relative monitoring metric for a second CSI prediction method from the set of second prediction methods is above a configured threshold, the WTRU may switch to the second CSI prediction method.

As another condition, if the value of the relative monitoring metric for a second CSI prediction method from the set of second CSI prediction methods is greater than the value of the relative monitoring metric for the first CSI prediction method, the WTRU may switch to the second CSI prediction method.

As another condition, if the value of the relative monitoring metric for a second CSI prediction method from the set of second CSI prediction methods is gradually improving compared to the value of the relative monitoring metric for the first CSI prediction method across a configured interval of the monitoring window, the WTRU may switch to the second CSI prediction method.

As another condition, if the value of the relative monitoring metric for a second CSI prediction method from the set of second CSI prediction methods exceeds a configured threshold over a configured minimum number of prediction instances, or over a configured minimum time-interval within the monitoring window, the WTRU may switch to the second CSI prediction method.

As another condition, if the number of monitoring instances for which a second CSI prediction method from the set of second CSI prediction methods performs better than the first CSI prediction method exceeds the number of monitoring instances for which the first CSI prediction method performs better than the second CSI prediction method, the WTRU may switch to the second CSI prediction method.

As another condition, if the value of the relative monitoring metric for a second CSI prediction method from the set of second CSI prediction methods exceeds a threshold over multiple time intervals and/or monitoring instances within the monitoring window.

In an example, the WTRU may use the determined/selected CSI prediction method for subsequent predictions (e.g., CSI predictions) and reporting for inference during the monitoring window (e.g., the WTRU may change the first CSI prediction method and/or foreground-active CSI prediction method). In this example, the WTRU may use the previous first CSI prediction method for subsequent performance metric computation during the rest of the monitoring window (but not for reporting).

In another example, the WTRU may collect values of the relative performance monitoring metric for the prediction instances within the monitoring window, report the outcome (e.g., the collected values) after the expiry of the monitoring window, and receive an indication from network to select/switch the foreground-active CSI prediction method according to a network indication based on a WTRU determination and/or the reported outcome.

In another example, a WTRU may compute a monitoring score and/or a value of the relative monitoring metric separately for each prediction instance (e.g., when N₄>1) and change the first CSI prediction method accordingly for each prediction instance within the prediction window. In this example, the selection per prediction instance may follow one or more of the conditions listed above.

In another example, the WTRU may determine multiple combinations of CSI prediction methods across the configured prediction window (e.g., based on measured applicable/channel conditions such as Time-Domain Channel Property (TDCP), WTRU speed, etc.). In this example, the WTRU may use dynamic and/or adaptive sets of CSI prediction methods according to the measured applicable/channel conditions for optimizing the individual performance of predictions within the prediction window.

A WTRU performing measurements for CSI prediction performance monitoring may report the monitoring measurement outcome, which may include one or more of: one or more values of the monitoring metric (e.g., the relative intermediate KPIs and/or intermediate KPIs) for CSI prediction methods, the monitoring output, one or more monitoring scores, and/or the selected CSI prediction method.

A monitoring-metric feedback report may include values of metrics for one or more active CSI prediction methods. For example, the monitoring-metric feedback report may include values of metrics for all and/or a subset of the active CSI prediction methods (e.g., for the foreground-active CSI prediction method and/or for the CSI prediction method(s) with top value(s) of the metric(s)).

The reported metrics for the one or more active CSI prediction methods may include one or more of the following types of metrics.

In an example, the reported metrics may include, for each monitoring instance in a monitoring window, a relative intermediate KPI between an active CSI prediction method and a configured benchmark CSI prediction method. The relative intermediate KPI may be SGCS or NMSE. Furthermore, the relative intermediate KPI may be reported per layer and/or or averaged over multiple layers.

In an example, the reported metrics may include, for each monitoring instance in a monitoring window, an intermediate KPI for an active CSI prediction method and for a configured benchmark CSI prediction method. The intermediate KPI may be reported per layer and/or averaged over multiple layers.

In an example, the reported metrics may include an average relative intermediate KPI between an active CSI prediction method and a configured benchmark CSI prediction method. The averaging may be performed over the duration of a monitoring window.

In an example, the reported metrics may include an average intermediate KPI for as active CSI prediction method and for a configured benchmark CSI prediction method. The averaging may be performed over the duration of a monitoring window.

The WTRU may also report the monitoring output. In an example, the monitoring output may be determined by comparing the monitoring metrics and/or relative monitoring metrics (e.g., intermediate KPIs and/or relative intermediate KPIs) to performance thresholds (e.g., if such thresholds have been included in the configuration information). In one example, the monitoring output may comprise comparison results for each instance in the monitoring window. In another example, the WTRU may determine (e.g., first determine) the average monitoring metric over the monitoring window and report the result of comparing the average monitoring metric to a threshold (e.g., if such a threshold has been included in the configuration information).

A monitoring-score feedback report may include monitoring scores for one or more active CSI prediction methods. For example, the monitoring-score feedback report may include monitoring scores for all and/or a subset of the active CSI prediction methods (e.g., for the foreground-active CSI prediction method and/or for the CSI prediction method(s) with a top score). In another example, if the WTRU switched the foreground-active CSI prediction method during the monitoring window, the monitoring-score feedback report may include the score of the updated foreground-active CSI prediction method (and, in some examples, may not include scores for the other CSI prediction methods).

The reported monitoring scores may include one or more of the following examples of types of monitoring scores.

In an example, the reported monitoring scores may include the number of instances for which an active CSI prediction method outperformed one or more benchmark CSI prediction methods.

In an example, the reported monitoring scores may include the relative number of times an active CSI prediction method outperformed one or more benchmark CSI prediction methods (e.g., relative to the monitoring window length).

In an example, the reported monitoring scores may include a bit map representing the instances within the monitoring window for which an active CSI prediction method outperformed one or more benchmark CSI prediction methods, where the length of the bitmap may equal the monitoring window length (e.g., as measured in terms of monitoring instances).

In an example, the reported monitoring scores may include a separate monitoring score for each prediction instance (e.g., if a monitored and/or active CSI prediction method is used to predict multiple future CSIs).

In an example, the WTRU may report a selected CSI prediction method when the WTRU determines to switch the foreground-active CSI prediction method during the monitoring window (and/or in response to determining to switch the foreground-active CSI prediction method). The WTRU may include (e.g., in a selected-prediction-method feedback report) an indicator for (e.g., an indication of) the selected CSI prediction method within a first scheduled uplink (UL) control channel (e.g., a Physical Uplink Control Channel (PUCCH)) transmission and/or a first scheduled UL data channel (e.g., a Physical Uplink Shared Channel (PUSCH)) transmission.

In an example, the WTRU may report the values of the monitoring metrics and/or relative metrics at the end of the configured monitoring window. In one example, the WTRU may include the values of the monitoring metrics/relative metrics with (e.g., in) a periodic and/or semi-persistent CSI feedback report. In another example, the WTRU may report the values of the monitoring metrics and/or relative metrics as a response to a network request. In yet another example, the WTRU may request a grant for UL resources when trigger conditions for reporting the monitoring metrics and/or relative metrics are met (e.g., satisfied).

In some examples, the WTRU may be configured with one or more relative monitoring metrics and/or WTRU-initiated CSI-Prediction-method change. For instance, the WTRU may be configured via configuration information that is received from the network and that indicates the one or more relative monitoring metrics and/or the enablement of WTRU-initiated CSI-Prediction-method change.

For a relative monitoring metric, the configuration information may indicate a benchmark CSI prediction method to be used in computing values of the relative monitoring metric. The benchmark CSI prediction method may be, for example, an S&H CSI prediction method and/or a non-AI CSI prediction method.

The configuration information may further indicate an intermediate KPI-based performance metric (e.g., that measures SGCS and/or NMSE) to be used in computing values of the relative monitoring metric.

The configuration information may further indicate the relative monitoring metric to be computed. The relative monitoring metric may be based on, for example, an intermediate KPI difference, a percentage of change, and/or a ratio of computed intermediate KPIs.

The configuration information may further indicate a monitoring-score-per-prediction method for computing the respective relative monitoring scores of CSI prediction methods. For instance, in some examples, the monitoring-score-per-prediction method may be the average intermediate KPI of a configured CSI prediction method relative to the average intermediate KPI of the configured benchmark CSI prediction method. Furthermore, in some examples, the monitoring-score-per-prediction method may involve determining a number of instances for which a CSI prediction method (e.g., an AI-based a CSI prediction method) performed better (e.g., produced more accurate prediction (e.g., higher SGCS or lower NMSE) than a benchmark a CSI prediction method (e.g., an S&H a CSI prediction method) and/or a non-AI CSI prediction method. Also, in some examples. The monitoring-score-per-prediction method may involve determining a number of instances for which one or more active a CSI prediction methods outperformed other CSI prediction methods (e.g., inactive CSI prediction methods).

The configuration information may further indicate a configuration for an inference CSI reference signal (CSI-RS) (e.g., an inference CSI-RS configuration).

In some examples, the inference CSI-RS configuration indicates that periodic and/or semi-persistent bursts of CSI-RSs are to be used (e.g., Persistent/Semi-Persistent (P/SP) configuration for Release 18 (Rel-18) Aperiodic CSI-RS).

Furthermore, in some examples, the inference CSI-RS configuration indicates that periodic and/or semi-persistent CSI-RSs are to be used.

The configuration information may further comprise an indication to enable WTRU-initiated CSI-prediction-method change (e.g., during a monitoring window). Furthermore, in some examples, the configuration information may further comprise one or more thresholds to apply to an average relative intermediate KPI such that, when a threshold is satisfied, the WTRU may change CSI prediction methods (e.g. switch from one CSI prediction method to another). The thresholds may depend on the specific CSI prediction methods that are being compared. For instance, a first threshold may be applied to a relative intermediate KPI between an AI CSI prediction method and a non-AI CSI prediction method, while a second threshold may be applied to a relative intermediate KPI between an AI CSI prediction method and an S&H CSI prediction method. Also, the configuration information may comprise one or more thresholds to apply to a number of instances such that, when a threshold is satisfied, the WTRU may change CSI prediction methods (e.g. switch from one CSI prediction method to another).

The configuration information may further indicate a prediction method (e.g., a CSI prediction method) for inference. For example, the configuration information may indicate a prediction method per prediction time instance.

The WTRU may receive one or more inference CSI-RSs, compute a predicted CSI via a first CSI prediction method (e.g., a foreground-active CSI prediction method) based on the one or more inference CSI-RS, and report the predicted CSI (e.g., to the network). In addition to being used for computing and reporting the predicted CSI during inference, the first CSI prediction method may be used for performance metric computation (e.g., for computing values of a relative monitoring metric, an intermediate KPI-based performance metric, etc.) based on one or more monitoring CSI-RSs.

The WTRU may receive a configuration for monitoring CSI-RSs (e.g., in the form of configuration information). The configuration information may indicate a monitoring window size (“Wₘ.”). In addition, the configuration information may indicate that periodic and/or semi-persistent bursts of CSI-RSs are to be used (e.g., P/SP configuration for Rel-18 Aperiodic CSI-RS). For example, the configuration information may indicate an association between one or more monitoring CSI-RSs and one or more inference CSI-RSs.

The WTRU may be configured with (e.g., receive configuration information that indicates) a set of one or more second CSI prediction methods (e.g., a set of background-active methods). The one or more second prediction methods may be used for performance metric computation (e.g., of respective values of a relative monitoring metric, respective values of an intermediate KPI-based performance metric, etc.) based on monitoring CSI-RSs.

The set of one or more second prediction methods may be determined and/or selected based on: activation of available CSI predictions methods, a determination of which CSI prediction methods are available, and/or indication from the network. The one or more second prediction methods in the set may be used for computing one or more respective predicted CSIs at the WTRU. However, in one example, the WTRU does not report the one or more respective predicted CSIs that were computed using the one or more second prediction methods (by contrast, the WTRU does report the predicted CSI that was computed using the first CSI prediction method in this example).

The WTRU may receives one or more inference CSI-RSs and/or one or more monitoring CSI-RSs during the monitoring window.

In addition, the WTRU may compute respective values of the relative monitoring metric for the first prediction method and for each of the one or more second prediction methods in the set (e.g., by comparing intermediate KPIs of the first prediction method and the one or more second prediction methods to intermediate KPIs of one or more benchmark CSI prediction methods such as S&H) based on the received one or more monitoring CSI-RSs.

For instance, in an example, the WTRU may compute a respective average relative intermediate KPI between each CSI prediction method (e.g., the first CSI prediction method and the one or more second CSI prediction methods) and a benchmark CSI prediction method (e.g., that was indicated via configuration information).

The WTRU may also compute a respective relative SGCS for each CSI prediction method (e.g., the first CSI prediction method and the one or more second CSI prediction methods) relative to the benchmark CSI prediction method and/or for each monitoring instance may be computed. As discussed above, a “monitoring instance” may refer to a ground-truth CSI that is measured via monitoring of a particular CSI-RS received within the monitoring window, which may be used to measure the intermediate KPIs (e.g., SGCS of the first and second CSI prediction methods).

The WTRU may compute a respective relative monitoring score for each CSI prediction method. In one example, the respective relative monitoring score for a CSI prediction method may comprise a number of monitoring instances for which the CSI prediction method outperformed the benchmark CSI prediction method (e.g., the CSI that the CSI prediction method predicted was more accurate than the CSI that the benchmark CSI method predicted).

In an example, the WTRU may compute the respective relative monitoring score for a CSI prediction method by computing a stream of bits. Each bit in the stream may correspond to a monitoring instance (e.g., such that consecutive bits correspond to consecutive monitoring instances). A value of one at a bit in the stream may indicate that the CSI prediction method outperformed the benchmark CSI prediction method for the monitoring instance (e.g., ground-truth CSI) to which the bit corresponds. For example, if the respective relative monitoring score for a CSI prediction method is represented by the stream of ten bits “1110110111,” then the CSI prediction method outperformed the benchmark CSI prediction method for eight out of ten monitoring instances (although the benchmark CSI prediction method performed better for the fourth and seventh monitoring instances).

In one option, the WTRU may compute a separate relative monitoring score for each prediction instance (e.g., predicted CSI) for N₄>1.

In another option, the WTRU may compute the top prediction method based on the monitoring-score-per-prediction method.

The WTRU may select a CSI prediction method from one of the first CSI prediction method or set of one or more second CSI prediction methods based on the computed respective values of the relative monitoring metrics for each of the first CSI prediction method and the one or more second CSI prediction methods in the set.

For example, the WTRU may select a second CSI prediction model from the set of one or more second CSI prediction models if the WTRU determines the respective value of the relative monitoring metric for the second CSI prediction model is greater than (or greater than by at least a threshold amount) that of the first CSI prediction model for a set of one or more prediction instances. (A “prediction instance” may refer to a predicted CSI that can be compared to a corresponding ground-truth CSI.)

In an example, the WTRU uses the selected second CSI prediction method for computing and reporting predicted CSIs during inference. The WTRU may use the first CSI prediction method for subsequent performance metric computation, but does not report CSIs predicted by the first CSI prediction method (e.g., because the selected second CSI prediction method serves the foreground-active CSI prediction method after being selected instead of the first CSI prediction method).

In another example, the WTRU may switch the CSI prediction method (e.g., the foreground-active CSI prediction method on which feedback reported to the network is based) based on a network indication (e.g., included in configuration information) after the end of the monitoring window.

Optionally, in some examples, the WTRU may compute relative monitoring scores separately for each prediction instance and change (e.g., switch) the CSI prediction method (e.g., the foreground-active CSI prediction method) for each prediction instance separately.

The WTRU may transmit a monitoring report to the network. The monitoring report may comprise one or more respective relative intermediate KPIs (e.g., average relative intermediate KPIs) for the first CSI prediction method and/or the one or more second prediction methods.

The monitoring report may comprise a respective relative monitoring score for each CSI prediction method (e.g., the first CSI prediction method, the one or more second CSI prediction methods, and/or the benchmark CSI prediction method).

The monitoring report may indicate the top-performing CSI prediction method (e.g., from among the first CSI prediction method, the one or more second CSI prediction methods, and/or the benchmark CSI prediction method) based on the respective relative monitoring scores.

The monitoring report may indicate the selected second CSI prediction method. At the arrow 206 in FIG. 2 (and at the arrow 306 in FIG. 3, the WTRU may receive a new inference configuration and/or receive confirmation of the new inference configuration (e.g., confirming which CSI prediction method to use as the foreground-active CSI prediction method). Other CSI prediction methods (e.g., CSI prediction methods other than the CSI prediction method that the new inference configuration indicates and/or confirms to be the foreground-active CSI prediction method) may be deactivated.

1-20. (canceled)

21. A wireless transmit/receive unit (WTRU) comprising:
a processor configured to:
receive configuration information, wherein the configuration information comprises an indication of a plurality of inference channel state information reference signals (CSI-RSs) and a plurality of monitoring CSI-RSs;
determine, based on the plurality of inference CSI-RSs and measurements performed on the plurality of monitoring CSI-RSs, a first squared generalized cosine similarity (SGCS) value for a CSI prediction method and a second SGCS value for a benchmark method; and
send a monitoring report that indicates the first SGCS value and the second SGCS value.

22. The WTRU of claim 21, wherein the first SGCS value is based on:
(i) the CSI prediction method;
(ii) predicted CSI values determined via the CSI prediction method for a plurality of monitoring instances, wherein the predicted CSI values are based on measurements performed on the plurality of inference CSI-RSs; and
(iii) the measurements performed on the plurality of monitoring CSI-RSs.

23. The WTRU of claim 22, wherein the second SGCS value is based on:
(i) the benchmark method;
(ii) benchmark CSI values determined via the benchmark method for the plurality of monitoring instances, wherein the benchmark CSI values are based on the measurements performed on the plurality of inference CSI-RSs; and
(iii) the measurements performed on the plurality of monitoring CSI-RSs.

24. The WTRU of claim 23, wherein the first SGCS value and the second SGCS value are associated with the plurality of monitoring instances, and wherein the monitoring instance is within a monitoring window.

25. The WTRU of claim 23, wherein each of the predicted CSI values is associated with a respective monitoring instance of the plurality of monitoring instances.

26. The WTRU of claim 23, wherein the processor is further configured to:
determine the predicted CSI values for the plurality of monitoring instances via the CSI prediction method based on the measurements performed on the plurality of inference CSI-RSs; and
determine the benchmark CSI values for the plurality of monitoring instances via the benchmark method based on the measurements performed on the plurality of inference CSI-RSs.

27. The WTRU of claim 23, wherein the predicted CSI values comprise predicted precoding matrix indicators (PMIs) and the benchmark CSI values comprise benchmark PMIs.

28. The WTRU of claim 21, wherein the benchmark method comprises a sample-and-hold CSI prediction method.

29. The WTRU of claim 21, wherein the configuration information comprises an indication of an association between the plurality of inference CSI-RSs and the plurality of monitoring CSI-RSs.

30. The WTRU of claim 21, wherein the configuration information further comprises a first threshold to be applied to an intermediate key performance indicator (KPI) between the CSI prediction method and the benchmark method.

31. A method performed by a wireless transmit/receive unit (WTRU), the method comprising:
receiving configuration information, wherein the configuration information comprises an indication of a plurality of inference channel state information reference signals (CSI-RSs) and a plurality of monitoring CSI-RSs;
determining, based on the plurality of inference CSI-RSs and measurements performed on the plurality of monitoring CSI-RSs, a first squared generalized cosine similarity (SGCS) value for a CSI prediction method and a second SGCS value for a benchmark method; and
sending a monitoring report that indicates the first SGCS value and the second SGCS value.

32. The method of claim 31, wherein the first SGCS value is based on:
(i) the CSI prediction method;
(ii) predicted CSI values determined via the CSI prediction method for a plurality of monitoring instances, wherein the predicted CSI values are based on measurements performed on the plurality of inference CSI-RSs; and
(iii) the measurements performed on the plurality of monitoring CSI-RSs.

33. The method of claim 32, wherein the second SGCS value is based on:
(i) the benchmark method;
(ii) benchmark CSI values determined via the benchmark method for the plurality of monitoring instances, wherein the benchmark CSI values are based on the measurements performed on the plurality of inference CSI-RSs; and
(iii) the measurements performed on the plurality of monitoring CSI-RSs.

34. The method of claim 33, wherein the first SGCS value and the second SGCS value are associated with the plurality of monitoring instances, and wherein the monitoring instance is within a monitoring window.

35. The method of claim 33, wherein each of the predicted CSI values is associated with a respective monitoring instance of the plurality of monitoring instances.

36. The method of claim 33, further comprising:
determining the predicted CSI values for the plurality of monitoring instances via the CSI prediction method based on the measurements performed on the plurality of inference CSI-RSs; and
determining the benchmark CSI values for the plurality of monitoring instances via the benchmark method based on the measurements performed on the plurality of inference CSI-RSs.

37. The method of claim 33, wherein the predicted CSI values comprise predicted precoding matrix indicators (PMIs) and the benchmark CSI values comprise benchmark PMIs.

38. The method of claim 31, wherein the benchmark method comprises a sample-and-hold CSI prediction method.

39. The method of claim 31, wherein the configuration information comprises an indication of an association between the plurality of inference CSI-RSs and the plurality of monitoring CSI-RSs.

40. The method of claim 31, wherein the configuration information further comprises a first threshold to be applied to an intermediate key performance indicator (KPI) between the CSI prediction method and the benchmark method.
